(19) United States
(12) Patent Application Publication
(10) Pub. No.: US 2007/0175972 A1
(43) Pub. Date: Aug. 2, 2007

(54) Manually actuated contactless card

(76) Inventor: Eric M. Ringer, Seattle, WA (US)

Correspondence Address: Eric Ringer, 1035 NE 100th St., Seattle, WA, 98125, US

(21) Appl. No.: 11/595,289

(22) Filed: Nov. 9, 2006

Related U.S. Application Data
(60) Provisional application No. 60/735,512, filed on Nov. 10, 2005.

(51) Int. Cl. G07G 1/00

(52) U.S. Cl. 235/3

(57) ABSTRACT

A manually actuated contactless card includes at least one manual actuator and a memory having at least one record of confidential information. The manually actuated contactless card provides the at least one record of confidential information to a reader when the manually actuated contactless card is energized by the reader provided that at least one of the manual actuators is simultaneously actuated.

### CROSS-REFERENCE TO RELATED APPLICATION

This application claims the benefit under 35 U.S.C. § 119(e) of U.S. Provisional Patent Application No. 60/735,512, filed Nov. 10, 2005, which is hereby incorporated by reference in its entirety.

### TECHNICAL FIELD

The present invention is generally related to a contactless card and, more particularly, is related to a manually actuated contactless card.

### BACKGROUND OF THE INVENTION

Wireless technology such as radio frequency identifier (RFID) devices are being embedded in may technologies and industries. Details regarding wireless devices may be found at:

http://www.rfid-handbook.de/downloads/E2E chapter03-rfid-handbook.pdf, the contents of which are hereby incorporated by reference; and at

http://www.aimglobal.org/technologies/rfid/resources/papers/rfid_basics_primer.asp, the contents of which are hereby incorporated by reference.

Financial institutions and the health care industry are two examples of disparate industries that are embracing wireless enabled cards, or contactless cards. Contactless cards are be used to carry personal information such as a person's medical history. Financial institutions are issuing contactless credit cards. These contactless credit cards allow card holders to conduct contactless transactions. A card holder can simply pass their contactless credit card in front of a card reader, and the card reader reads the information necessary for completing the transaction from the contactless credit card.

Contactless cards are also being used to as “keys” to buildings, elevators, and doors. The contactless card is waived in front of a reader, which is in communication with a central security system. Based upon information read from the contactless card, the central security system may unlock a locked entry point so that the holder of the contactless card may pass therethrough. Typically, the reader may be able to read the contactless card while the contactless card is in a pocket, wallet, purse, etc. such that the holder of the contactless card does not have to remove the contactless card from the pocket, wallet, purse, etc. in order to use the contactless card to gain entry.

Contactless cards do provide the holders of the contactless cards with ease of use. Contactless card holders don't have to physically handle the contactless card and swipe the contactless card through a magnetic card reader, nor hand the card to a sales clerk. However, because contactless cards are frequently used to carry confidential information such as medical histories, financial information, etc. a need exits to protect the confidentiality of the information carried by the contactless cards.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a loader system that loads confidential information into a manually actuated contactless card.

FIG. 2 is a block diagram of memory in the loader system of FIG. 1.

FIG. 3 is a block diagram of a manually actuated contactless card having a single manual actuator.

FIG. 4 is a block diagram of a manually actuated contactless card having multiple manual actuators.

FIG. 5 is a block diagram of a manual actuator.

FIG. 6 is a block diagram of a manual actuators.

FIG. 7 is a diagram of a manually actuated contactless card having multiple manual actuators.

FIG. 8 is a flow chart of step for using a manually actuated contactless card.

### DETAILED DESCRIPTION

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

An aspect, which may be common to several embodiments, is that a manually actuated contactless card includes a memory having confidential information and a manual actuator. In some embodiments, the manual actuator includes a button that a user depresses so as to actuate the manually actuated contactless card, wherein the manually actuated contactless card is inoperable for transferring confidential information without the button being depressed. In some embodiments, a manually actuated contactless card may include multiple actuation buttons and a memory having confidential information, wherein the manually actuated contactless card is inoperable for transferring confidential information without at least one actuation button being depressed. In some embodiments, the manual actuator includes circuitry that is closed by a touch of a user. In some embodiments, the circuitry might include a manual actuator that is closed through capacitive and/or inductive coupling with human skin.

Another aspect, which may be common to several embodiments, is that a loader system may be used for loading one or more records of the confidential information into a manually actuated contactless card. In some embodiments, the loader system may be located at a place of business such as a retailer of manually actuated contactless cards. The business operator or a purchaser of a manually actuated contactless card may use the loader system to load one or more records of confidential information provided by the customer into a memory of the manually actuated contactless card. In some embodiments, records of confidential information may be read by a magnetic card reader and some or all of the records of confidential information may be transferred to the memory of manually actuated contactless card by the loader system. In some embodiments, the loader system includes an interface such as a keyboard and monitor and confidential information is input into the loader system, and the inputted confidential information, or some of the inputted confidential information, is transferred to a manually actuated contactless card. In some embodiments, a loader system may be located at an end-user's business, office, home, etc.

It should be noted that confidential information includes, but is not limited to, financial information, medical information, personal information, and lock codes. By way of non-limiting example, financial information includes information frequently included in a magnetic strip of a conventional card such as, but not limited to, a credit card, a debit card, an Automatic Teller Machine (ATM) card, a payroll card. It should be noted that debit cards include account debit cards, which may be associated with an account such as, but not limited to, a checking account and/or savings account, and prepaid debit cards, which have an initial monetary value that decreases as the card is used to make payments and which may be rechargeable.

Confidential medical information may include medical history of a person. The medical history of a person might include names of: drugs that are prescribed for the person; drugs the person is taking; and drugs that the person has taken in the past. Furthermore, the medical history might include the level of drug use such as the frequency that the person is meant to take the drugs and the prescribed dosage. Medical history might include: chronic diseases experienced by the person; non-chronic diseases experienced in the past; non-chronic disease currently being experienced by the person. In addition, the medical history might include the treatments that the person has experienced in the past and/or the treatment that the person is currently undergoing. The confidential medical history may also include the names of medical service providers and may also include insurance information.

Personal information may include contact information such as home (residence) address, telephone number (home/mobile etc.), private email address, and social security number. In addition, personal information may include contact information such as work address, telephone number (work/mobile etc.), work email address, social security number, and employee identifier.

Confidential information carried by manually actuated contactless cards also includes lock codes that when provided to a lock causes the lock to unlock. In some embodiments, a manually actuated contactless card may include a lock code that identifies an authorized person, i.e., the person to whom the manually actuated contactless card has been issued. In some embodiments, a manually actuated contactless card may include a lock code that is a key, which may or may not be unique to the authorized person. When the manually actuated contactless card is waived in front of a reader, the reader retrieves the key code and determines whether to unlock an access point. The reader may compare the key code with a stored key code, and determine whether to unlock the access point based upon the comparison. Alternatively, the reader may provide the key code to a central security system, which determines whether to unlock the access point.

In some embodiments, a manually actuated contactless card may be used to carry multiple key codes. In this manner, a user may have a single manually actuated contactless card that may be used to gain access to his or her place of employment and his or her residence and/or to multiple offices. Using manual actuators on the manually actuated contactless card, the user may select which key code is provided to a reader. This allows a user to use the same manually actuated contactless card with multiple security systems. When the user waives the manually actuated contactless card in front of a reader, the reader receives the key code selected by the user. Thus, to the security system the manually actuated contactless card appears the same as a conventional manually actuated contactless card.

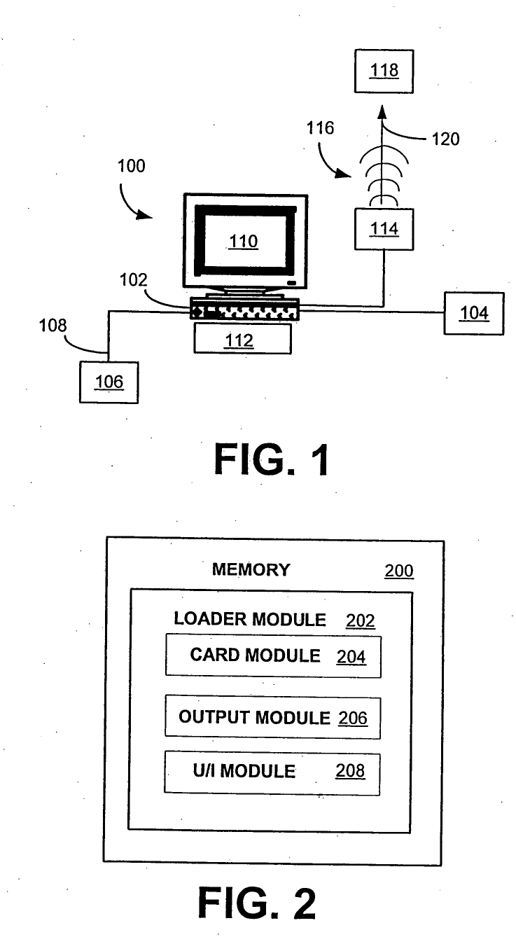

Referring to FIG. 1, a loader system 100 is used to load records of confidential information into a manually actuated contactless card 106. The loader system 100 according to one illustrated embodiment includes a computer system 102 and a magnetic card reader 104. In some embodiments, during the loading of one or more records of confidential information into the manually actuated contactless card 106, the manually actuated contactless card 106 is coupled to the computer system 102 by a cable 108. The computer system 102 may be a conventional computer system having a monitor 110 and a keyboard 112.

In some embodiments, the loader system 100 includes a wireless writer 114. The wireless writer 114 is adapted to emit electromagnetic energy 116 of sufficient amplitude and appropriate frequency to energize a manually actuated contactless card 118. The wireless writer 114 is also adapted to transmit a signal 120 to the manually actuated contactless card 118. The signal 120 carries one or more records of confidential information to the manually actuated contactless card 118, and the manually actuated contactless card 118 then stores the one or more records of confidential information in a memory. It should be noted that the wireless writer 114 may also be reader/writer, which is adapted to read confidential information from the manually actuated contactless card 118.

In some embodiments, the manually actuated contactless card 106 may be energized by the cable 108 during loading of confidential information. For example, the manually actuated contactless card 106 may include a Universal Serial Bus port for receiving the cable 108, which is a USB cable, and power and confidential information is passed to the manually actuated contactless card 106 via the cable 108.

The magnetic card reader 104 may be a conventional magnetic card reader adapted to read a magnetic strip on a card. Typically, cards such as, but not limited to, credit cards, debit cards, ATM cards, payroll cards, and keyless entry cards include a magnetic strip having information stored therein. The magnetic card reader 104 reads information from conventional cards and provides the information to the computer system 102. The computer system 102 includes a loading module (not shown) that receives the information and provides some or all of the information to either or both of the manually actuated contactless cards 106 and 118. Sometimes the keyboard 112 is used to input information, which may be displayed on the monitor 110, and the information may then be provided to either or both of the manually actuated contactless cards 106 and 118.

It should be noted that other embodiments of a loader system are contemplated. For example, in some embodiments, the loading module might be included in a register such as a cash register. In other embodiments, the loader system might comprise a kiosk.

FIG. 2 illustrates a computer readable memory 200 of the loader system 100 according to one illustrated embodiment. A loader module 202 stored in the memory 200. The loader module 202 includes a card module 204, a output module 206, and a user interface module 208. The card module 204 is configured to interface with the magnetic card reader 104 and receive the information read by the card reader 104. The card module 204 may also be configured to interface with the wireless writer 114. Thus, in the event that the wireless writer 114 is a reader/writer, the card module 204 is configured to interface with the reader/writer and receive information, which has been read from the manually actuated contactless card 118.

The user interface module 208 is configured to provide menus that are displayed on the monitor 110. The menus enable a user to, among other things, select options, and in conjunction with the use of the keyboard 112 to input information. As will be explained in detail hereinbelow, selecting options includes, but is not limited to, associating information with a button (not shown) on a manually actuated contactless card. Thus, in some embodiments, a first record of confidential information is associated with a first manual actuator on the manually actuated contactless card, and a second record of confidential information is associated with a second manual actuator. In addition, selecting options includes, but is not limited to, selecting records of confidential information to add to a memory of the manually actuated contactless card 106 and/or 108, and selecting which records of confidential information, if any, that are currently stored in the manually actuated contactless card 106 and/or 108 to delete.

The output module 206 is configured to interface with the wireless writer 114 and provide information to the manually actuated contactless card 118 and to interface with the manually actuated contactless card 106. The output module 206 is also configured to receive information from the user interface module 208 and from the reader module 204 and provide some or all of the received information to one or both of the manually actuated contactless cards 106 and 118. The output module 206 may also be configured to, among other things, format the received information according to a predetermined protocol. For example, in one embodiment, the manually actuated contactless cards 106 and 108 may be Radio Frequency Identifier cards, and the output module 206 may format the received information into a protocol conforming to ISO/IEC 14443. In other embodiments, the manually actuated contactless cards may be other ISO/IED 14443 technologies such as, but not limited to, Bluetooth, Near Field Communication (NFC) RFID, and IR.

The loader module 202 allows the loader system 100 to determine memory availability for the manually actuated contatctless cards 106 and 118. The loader module 202 can help prevent the accidental overwriting of records of confidential information stored in the manually actuated contatctless cards 106 and 118 by providing the manually actuated contatctless cards 106 and 118 with a number of records of confidential information such that the memory requirements for the number of records of confidential information does not exceed the currently available memory.

In some embodiments, the memory of the manually actuated contatctless cards 106 (and/or 118) may be partitioned into blocks and each block may be associated with one manual actuator. The loader module 202 allows the loader system 100 to store a record of confidential information in an appropriate block of memory. The appropriate block may be determined by the loader module 202, e.g., an appropriate block was one that was previously empty. Alternatively, the loader module 202 may determine the appropriate block based upon user input, e.g., the user may select an option that associates a particular record of confidential information with a particular manual actuator.

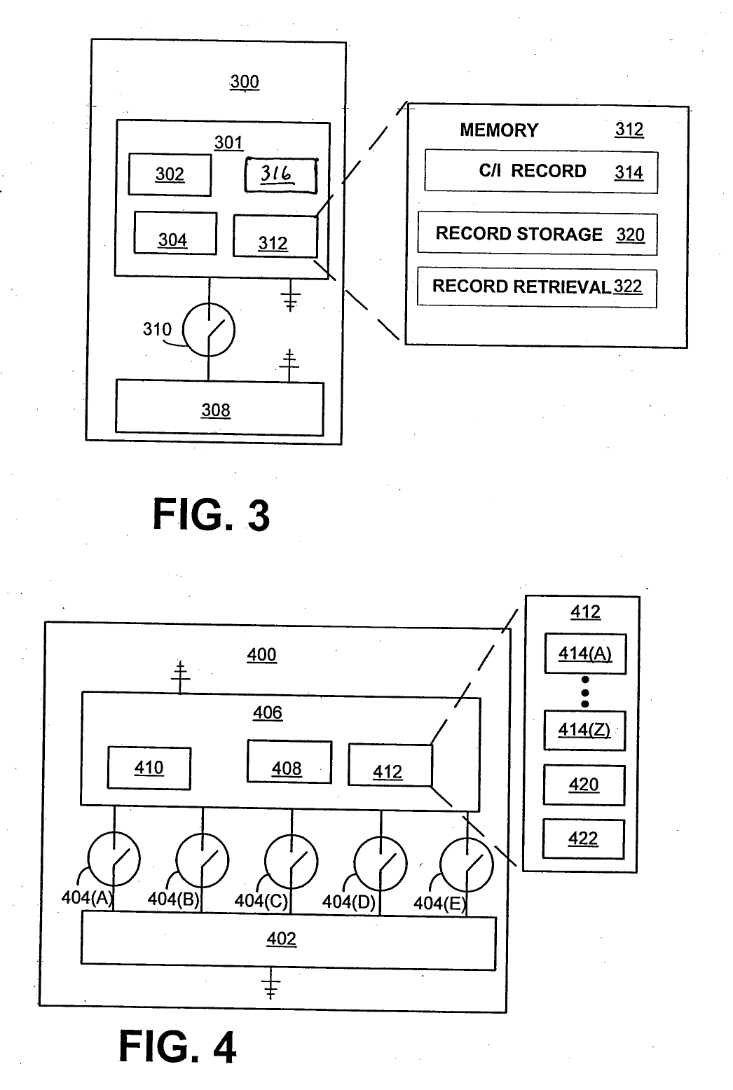

An exemplary embodiment of a manually actuated contactless card 300 is shown in FIG. 3. The manually actuated contactless card 300 includes a digital component 301, an energy source 308, and a manual actuator 310. The digital component 301 includes a transponder 304, a processor 302 and a memory 312. Among other things, the memory 312 includes at least one record of confidential information 314, which may have been loaded into the memory 312 by the loader system 100, a record storage module 320, and a record retrieval module 322. Typically, the memory 312 may be EEPROM or flash memory or Read-Only-Memory (ROM) and/or other memory including non-volatile memory and volatile memory.

The processor 302 implements the record storage module 320 to store records of confidential information in the memory 312. The record storage module 320 may also be configured to assign a record identifier with a stored record of confidential information. Typically, the record identifier is used to retrieve the record of confidential information. In some embodiments, a manually actuated contactless card includes multiple manual actuators and the record identifier for a record of confidential information may be associated with one of the manual actuators.

The processor 302 implements the record retrieval module 322 to retrieve stored records of confidential information 314. As previously described, in some embodiments, the manually actuated contactless card includes multiple manual actuators, and the record retrieval module is configured to identify which manual actuator has been actuated and use the record identifier associated with the actuated manual actuator. The record retrieval module uses the record identifier to retrieve the record of confidential information identified by the record identifier.

The energy source 308 provides energy to the digital component 301. Typically, the energy source 308 may be a passive energy source that is adapted to receive electromagnetic energy 116 from a contactless reader (not shown) and/or from the wireless writer 114. Typically, a passive energy source may include an inductor and/or antenna coil (not shown) that receives the electromagnetic energy 116 and components and circuitry (not shown) that modulates the energy from the inductor. In some embodiments, the energy source 308 may include an active energy source such as a battery. In some embodiments, the energy source 308 may include both active and passive components.

The manual actuator 310 is adapted to be manually actuated. In the embodiment illustrated in FIG. 3, when the manual actuator 310 is actuated it is closed, thereby closing the electrical circuit and allowing the digital component 301 to receive energy from the energy source 308. Those skilled in the art recognize that in alternative embodiments, the digital component 301 may be actuated by the opening of a manual actuator. (Assume a circuit having the digital component is in parallel to a manual actuator that goes directly to ground. If the manual actuator is closed, (i.e., in its natural, non-actuated state), then the digital components are not powered. Whereas, if the manual actuator is opened and the energy source has energy, then the digital components are powered by the energy source.)

When the digital component 301 receives energy, the processor 302 may retrieve the record of confidential information 314 from the memory 312 and provide the record of confidential information to the transponder 304. Among other things, the transponder 304 may process the record of confidential information from the processor 302 and transmit at least a portion of the record of confidential information. In some embodiments, the transponder 304 receives a signal (or query or interrogation), which is passed to the processor 302, and the processor 302 responds to the signal by providing the record of confidential information 314 to the transponder 304, which may then transmit the record of confidential information 314. Typically, the received signal is from a contactless card reader.

In some embodiments, the transponder 304 may receive information such as records of confidential information from the wireless writer 114. The transponder 304 passes the information to the processor 302, and the processor 302 stores the records of confidential information in the memory 312 using the record storage module 320.

In some embodiments, manually actuated contactless card 300 may include a port 316. The port 316 is adapted to receive information such as a record of confidential information and provide the information to the digital component 301. Typically, the port 316 is adapted to receive both information and to provide the digital component with energy. In some embodiments, the port 316 may be a USB port.

FIG. 4 illustrates selected components of another embodiment of a manually actuated contactless card 400. The manually actuated contactless card 400 includes an energy source 402, a plurality of manual actuators which are collectively referenced as 404 and individually referenced as 404(A)-404(E), and a digital component 406. The energy source 402 may be the same as the energy source 308, and consequently, the energy source 402 is not discussed in detail.

The digital component 406 includes a processor 408, a transponder 410, and a memory 412. Stored in the memory 412 is a record storage module 420, a record retrieval module 422, and a plurality of records of confidential information, which are collectively referenced as 414 and individually referenced as 414(A)-414(Z). For the sake of this disclosure, a record of confidential information is comprised of related data, which may be defined by a user or by a provider of the confidential information. For example, a record of confidential information may include information related to a credit account; another record of confidential information may include information related to a debit account; another record of confidential information may include information related to a payroll account. Other examples of a record of confidential information include a key code for a lock, information related to contact information, and information related to medical history. As will be explained in detail hereinbelow, it should be noted that the number of records of confidential information 414 do not need to correspond on a one-to-one basis with the numbers of manual actuators 404. The record storage module 420 is generally the same as the record storage module 320. Similarly, the record retrieval module 422 is generally the same as the record retrieval module 320. Therefore, the record storage module 420 and record retrieval module 422 are not discussed in detail.

In this embodiment, when the energy source 402 is energized, the manually actuated contactless card 400 is configured to provide a record of confidential information 414 to a contactless reader (not shown). Which record of confidential information 414 that is provided depends upon which manual actuator 404 or combination of manual actuators 404 are actuated. Each record of confidential information 414 is associated with a predetermined manual actuator 404 or combination manual actuators 404. For example, each one of the records 414(A)-414(E) may be associated with one of the manual actuators 404(A)-404(E), respectively; records 414(F)-414(I) may be associated with the manual actuator 404(A) in conjunction with one of the manual actuators 404(B)-404(E), respectively, and so on. It should be noted that a record of confidential information may be associated with more than two manual actuators operating in conjunction. When the manually actuated contactless card is energized, the processor 408 determines which manual actuator 404 or combination of manual actuators 404 have been actuated and retrieves the appropriate record of confidential information 414. The processor 408 provides the transponder 410 with the retrieved record of confidential information 414, which then transmits the record of confidential information 414 to a contactless reader (not shown). It should be noted that records of confidential information 414 may be loaded into the memory 412 as described with respect to the embodiment of FIG. 3.

In some embodiments, the record storage module 420 might be configured to associate a record of confidential information with the actuation of a sequence of manual actuators, and the record retrieval module 422 may be configured to allow a user to retrieve a record of confidential information by sequentially actuating multiple manual actuators. For example, a user might sequentially actuate manual actuators 404(A), 404(B), and 404(C) to retrieve the record of confidential information 414(Z).

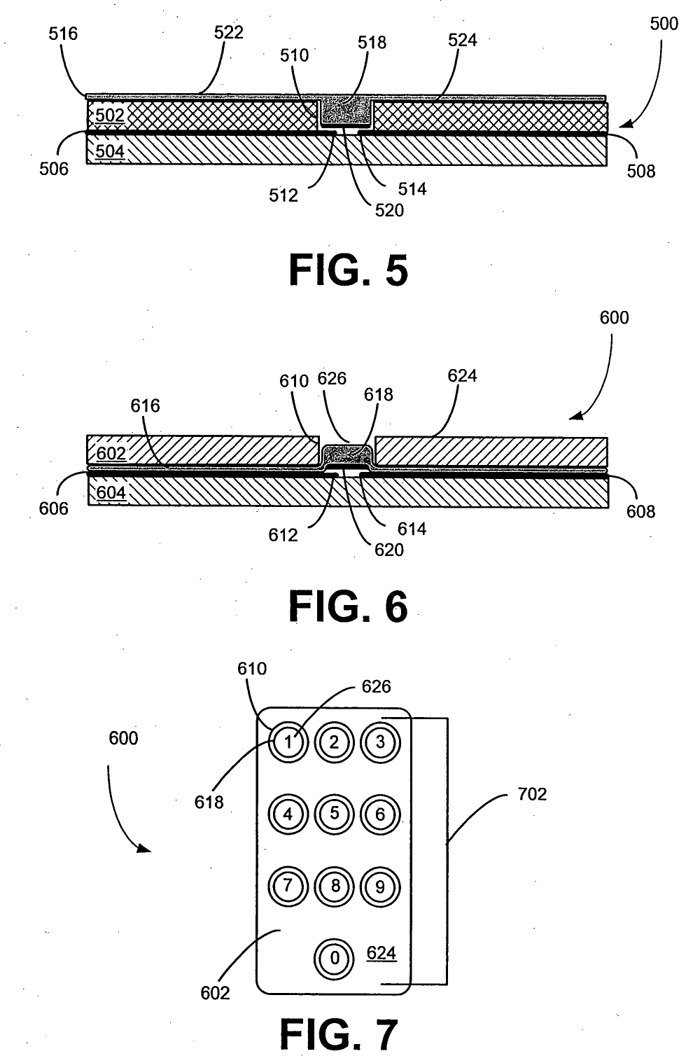

FIG. 5 illustrates an embodiment of a manual actuator 500. A manually actuated contactless card includes a rigid member 502 having an upper surface 524 and a substrate 504. In some embodiments, the rigid element is selected from a material such as a polymer or plastic or a type of material used in the manufacture of conventional magnetic strip credit cards.

The substrate 504 includes an electrical conductor 506 and an electrical conductor 508, which are not in electrical communication. The rigid member 502 defines an opening 510, and the electrical conductors 506 and 508 have electrical conductor ends 512 and 514 that extend into the opening 510. A pliable member 516, which may be chosen from materials that are not electrically conductive, having a plug 518 is disposed on the rigid member 502. The plug 518 is disposed in the opening 510. The plug 518 has a electrically conductive contact element 520 disposed thereon. When the pliable member 516 is in its relaxed state, the pliable member 516 is configured to hold the plug 518 in general proximity to the electrical conductor ends 512 and 514 without having the contact element 520 engaging the electrical conductor ends 512 and 514. When a downward force is applied to the pliable member 516 in the region that is generally above the plug 518, the pliable member 516 reacts to the downward force such that the plug 518 moves elastically downward towards the electrical conductor ends 512 and 514. In operable position, the contact element 520, which is an electrical conductor, simultaneously contacts the ends 512 and 514 of the electrical conductor 506 and 508, respectively, thereby bringing the electrical conductors 506 and 508 into electrical communication.

In some embodiments, the pliable member 516 has an upper surface 522 that is a generally planar surface in its relaxed state. The pliable member 516 may elastically deform in response to a downward force applied in proximity to the opening 510 thereby forming a depression in the upper surface 522. The depth of the depression corresponds approximately to the downward vertical distance that the plug 518 has traveled. In some embodiments, the distance between the contact element 520 and the wire ends 512 and 514 may be chosen such that upper surface 522 must be pressed into or almost into the opening 510 (beneath or parallel to the upper surface 524 of the rigid member 502).

FIG. 6 illustrates an embodiment of a manual actuator 600. A manually actuated contactless card includes a rigid member 602 having an upper surface 624 and a substrate 604. The substrate 604 includes an electrical conductor 606 and an electrical conductor 608, which are not in electrical communication. The rigid member 602 defines an opening 610, and the an electrical conductors 606 and 608 have ends 612 and 614 that are disposed under the opening 610.

A pliable member 616 having a pad 618 interposes the rigid member 602 and the substrate 604. The pliable member 616 is selected from materials that are not electrically conductive. The pad 618 is disposed in the opening 610. The pad 618 has a contact element 620 disposed thereon. The contact element 620 is selected from materials that are electrically conductive.

When the pliable member 616 is in its relaxed state, the pad 618 having an upper surface 626 lies beneath the upper surface 624 of the rigid element 602 and the contact element 620 is in general proximity to the electrical conductor ends 612 and 614. The opening 610 is shaped to receive a portion of a human finger or thumb. When a downward force is applied to the upper surface 626 of the pad 618, the pad 618 moves elastically downward towards the wire ends 612 and 614, and the contact element 620 engages the electrical conductor ends 612 and 614. In operable position, the contact element 620 engages the electrical conductor ends 612 and 614 so that the electrical conductor 606 and 608 are in electrical connectivity.

FIG. 7 illustrates the manually actuated contactless card 600, as seen from above, having a number pad 702. As illustrated, the rigid element 602 defines a plurality of openings 610. A pad 618 (or button) is disposed in each of the openings 610. To use the manually actuated contactless card 602, a user simply depresses at least one of the pads (or buttons) 618 while energizing the manually actuated contactless card. Frequently, the manually actuated contactless card is energized by bringing the manually actuated contactless card in proximity to a contactless card reader (not shown), and electro-magnetic energy from the contactless card reader energizes the manually actuated contactless card. In this embodiment, while the manually actuated contactless card is energized, pressing one or more of the pads 618 causes one or more manual actuators to be closed, thereby causing a record of confidential information to be transmitted from the manually actuated contactless card.

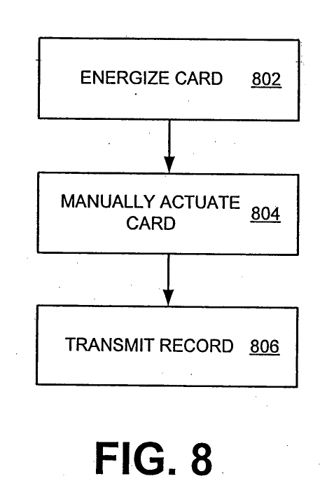

FIG. 8 illustrates exemplary steps for using a manually actuated contactless card in, among other things, a financial transaction. In step 802, a manually actuated contactless card is energized. The manually actuated contactless card may be energized by bring the manually actuated contactless card within a predetermined distance of a contactless reader such that an electro-magnetic energy field from the contactless reader energizes the manually actuated contactless card. The manually actuated contactless card may also be energized from an energy source such as a battery. In step 804, a user manually actuates at least one manual actuator on the manually actuated contactless card. The user may manually actuate the manual actuator by depressing a button.

In step 806, the manually actuated contactless card provides a record of confidential information to the contactless card reader.

It should be noted that the manually actuated contactless card may include, among other things, a plurality of records of confidential information. Thus, a single manually actuated contactless card may include record(s) of confidential information for a user's credit card (or multiple credit cards); record(s) of confidential information for a user's ATM card (or multiple ATM cards); record(s) of confidential information for a user's debit card (or multiple debit cards); record(s) of confidential for a user's payroll account (or multiple accounts). Thus, an advantage, among other advantages, is that user can reduce the number of conventional magnetic strip cards that the user might otherwise carry.

It should be noted that a manually actuated contactless card has security advantages over a conventional manually actuated contactless cards. A thief cannot simply set up a contactless card reader to surreptitiously read confidential information from manually actuated contactless cards because manually actuated contactless cards need a user manually actuate them in order to transmit confidential information to the contactless card reader.

It should be noted the above steps can be used in situations outside of financial transactions. For example, in one embodiment, a manually actuated contactless card may be used as a contactless key. A user might manually actuate a manual actuator on a manually actuated contactless card. The manually actuated contactless card may be energized by a card reader. The manually actuated contactless card provides the confidential information, which may be a key code for opening a door.

It should be noted that a single manually actuated contactless card might include multiple records of confidential information, wherein the multiple records of confidential information include multiple key codes. Thus, a user can use a single manually actuated contactless card to open multiple doors. In some existing systems, doors may be unlocked by a magnetic card being read by a magnetic card reader. However, each system normally requires a separate magnetic card. An advantage, among others, is that a user can use a single manually actuated contactless card to carry key codes for multiple systems. For example, the user can use his or her manually actuated contactless card to open doors at work and home and at other locations.

Another advantage of manually actuated contactless cards is that they may be used for securely carrying and providing contact information. In some embodiments, a parent might provide a manually actuated contactless card having contact information to a young child. The child would be able to carry the manually actuated contactless card, and if the child were separated from his or her parent(s), the authorities can use the contact information in the manually actuated contactless card to help return the child to his or her parent(s). Furthermore, a stalker or child predator cannot steal the contact information with a contactless card reader unless the manually actuated contactless card was actuated.

It should be noted that in some embodiments a manually actuated contactless card may include a number pad, similar to the number pad illustrated in FIG. 6, and enhanced security features such as having a pin (personal identification number) stored in its memory. After the card is energized, the user might be required to enter a pin (personal identification number), which is then compared to the pin stored in the memory of the manually actuated contactless card, in order to use the manually actuated contactless card. Unless the user entered the correct pin, the manually actuated contactless card will not transmit records of confidential information.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method of using a manually actuated contactless card, the method comprising the steps of:
manually actuating a manual actuator, wherein a manually actuated contactless card includes the manual actuator;
energizing the manually actuated contactless card, wherein the manually actuated contactless card includes a record of confidential information, wherein the manually actuated contactless card is energized while the manual actuator is actuated; and
providing at least a portion of the record of confidential information, wherein the record of confidential information is provided in response to the manually actuated contactless card being energized with the manual actuator actuated.

2. The method of claim 1, wherein the step of actuating the manual actuator further includes depressing a button.

3. The method of claim 2, wherein depressing the button closes an electric circuit.

4. The method of claim 2, wherein depressing the button opens an electric circuit.

5. The method of claim 1, further including the step of:
selecting a specific button from a plurality of buttons, wherein the manually actuated contactless card includes the plurality of buttons, wherein the record of confidential information is stored in a portion of memory of the manually actuated contactless card, wherein the portion of the memory is associated with the specific button;
responsive to both actuation of the manual actuator and energizing the manually actuated contactless card, retrieving the record of confidential information from the portion of the memory.

6. A manually actuated contactless card comprising:
a memory having a record of confidential information stored therein;
a manual actuator in electrical communication;
a transponder in electrical communication of with the manual actuator and the memory, wherein the transponder transmits the record of confidential information only if the manual actuator has been manually actuated.

7. The manually actuated contactless card of claim 6, further including:
a second record of confidential information, which is stored in the memory; and
a second manual actuator, wherein the transponder transmits the second record of confidential information only if the second manual actuator has been manually actuated.

8. The manually actuated contactless card of claim 6, further including:
a power source that provides an electrical current; and
a conductive material connecting the power source, the memory, the manual actuator, and the transponder, wherein the conductive material, the memory, the manual actuator, and the transponder comprise a circuit, wherein the electrical current carried in the circuit is provided only by the power source.

9. The manually actuated contactless card of claim 8, wherein the power source includes an inductor.

10. The manually actuated contactless card of claim 8, wherein the power source includes a battery.

11. The manually actuated contactless card of claim 6, wherein the record of confidential information is related to at least one of: a credit account; a debit account; a checking account; a savings account; a key code; contact information; a payroll account; and a medical history.

12. The manually actuated contactless card of claim 11, wherein the manually actuated contactless card is configured to be used at an Automatic Teller Machine.

13. A system comprising:
a writer configured to communicate records of confidential information to a manually actuated contactless card; and
computing device configured to interface with the writer, wherein the computing device provides the records of confidential information to the writer, wherein records of confidential information communicated to the manually actuated contactless card are associated with manual actuators that are manually actuated.

14. The system of claim 13, further including:
a reader configured to read a record of confidential information from a magnetic stripe of a card and provide the record to the computing device, wherein the computing device provides the record of confidential information from the magnetic stripe to the manually actuated contactless card.

15. Logic embodied in a computer readable medium, the logic comprising:
a record storage module configured to store records of confidential information in a memory of a manually actuated contactless card; and
a record retrieval module configured to retrieve a specific record of confidential information in response to at least one manual actuator being actuated.

16. The logic of claim 15, wherein the record retrieval module retrieves the specific record of confidential information in response to a plurality of manual actuators being sequentially actuated.

17. The logic of claim 15, wherein the record retrieval module retrieves the specific record of confidential information in response to a plurality of manual actuators being simultaneously actuated.

18. A manually actuated contactless card comprising:
a memory configured to have a plurality of records of confidential information stored therein;
a plurality of manual actuators configured to be manually actuated;
a passive energy source that provides power to the manually actuated contactless card in response to the manually actuated contactless card being placed in an electromagnetic field of a reader; and
a processor in communication with the memory and the passive energy source and the plurality of manual actuators, wherein the processor retrieves a specific record of confidential information from the memory only when receiving energy from the passive energy source and in response to at least one manual actuator being actuated.
